(19) United States
(12) Patent Application Publication
(10) Pub. No.: US 2021/0337849 A1
(43) Pub. Date: Nov. 4, 2021

(54) METHOD OF PRODUCING ANIMAL FAT SAUCE BY EMULSION WITH A HIGH-SHEAR MIXER

(71) Applicant: Mike Oraschewsky, Havertown, PA (US)

(72) Inventor: Mike Oraschewsky, Havertown, PA (US)

(21) Appl. No.: 17/246,392

(22) Filed: Apr. 30, 2021

Related U.S. Application Data
(60) Provisional application No. 63/017,897, filed on Apr. 30, 2020.

(51) Int. Cl. A23L 27/60; A23L 27/00; A23L 33/15; A23L 27/10

(52) U.S. Cl. CPC A23L 27/66; A23L 27/80; A23L 33/15; A23V 2250/712; A23V 2200/02; A23V 2250/54246; A23V 2250/02; A23L 27/10

(57) ABSTRACT

Producing sauce (e.g., mayonnaise) using animal fat on a commercial scale to obtain the quantity, quality, and life of traditional commercial-grade sauce made with common fruit, nut, seed, flower, and vegetable oils. An industrial-grade emulsifying machine such as a high-shear mixer is utilized to ensure that the animal fat particles are made sufficiently small to produce a good emulsion. An anti-rancidity or antioxidant (e.g., vitamin E, rosemary oil extract (ROE), bovine casein hydrolysate (BCH)) is utilized to prevent the animal fat from becoming rancid and enabling longer shelf life. The animal fat offers many benefits over traditional fruit, flower, nut, vegetable, and seed oils including being cheaper and more plentiful commercially, better-tasting and health benefits, including anti-carcinogenic properties.

### PRIORITY

This application claims the benefit under 35 USC § 119 of U.S. Provisional Application 63/017,897 filed on Apr. 30, 2020. Application 63/017,897 is herein incorporated by reference in their entirety.

### BACKGROUND

Mayonnaise, a staple condiment and base for many other sauces and dressings, fundamentally comprises a flavored blend of fat particles suspended in water. Normally, the chemical compositions of fat and water cause them to repel one another when mixed. Thus, the ingredients require an emulsifier and a stabilizing agent to cohesively combine, in a process called emulsion, whereby one liquid is slowly added to another together with simultaneous rapid mixing. The mixing disperses and suspends tiny droplets of one liquid through the other. The emulsifier prevents the two mixed liquids from separating again immediately.

In traditional mayonnaise, the common emulsifier is egg yolk, which contains lecithin, a chemical compound with one end that attracts water and repels fat, and a second end that repels water and attracts fat, allowing the water and fat particles to respectively bond with the lecithin and stay mixed instead of separating. Another common foundational ingredient in mayonnaise is an acid such as vinegar, lemon juice or lime juice. Though not strictly mandatory, an acidic ingredient provides additional water for the fat particles to emulsify in, and by its chemical properties, enables the absorption of more fat by the lecithin in the egg yolk to make stronger-bonding and greater quantities of mayonnaise. Traditional mayonnaise commonly utilizes oil from fruits, flowers, nuts, vegetables, or seeds such as olive, canola, or vegetable oil as its source of fat particles, primarily because of their convenience, availability, and neutral taste.

The ingredients are mixed together in order to create the mayonnaise. The smaller the size of the fat particles created in the mixing process the more stable the mayonnaise is (less likely it is to have the oil and water separate). Commercially sold mayonnaise is made with an industrial-grade emulsifying machine such as a high-shear mixer that can combine and produce a large quantity of mayonnaise at a faster rate and with greater mixture stability. A high-shear mixer has the capability to reduce the size of fat particles in the emulsion to their smallest size. The small fat particle size increases the storage stability period of the resultant mayonnaise, the mayonnaise does not separate for a longer period of time. If the ingredients for an emulsion are not properly dispersed or reduced in size, they are likely to quickly separate and break the emulsion, making it unviable for commercial sale.

### BRIEF DESCRIPTION OF DRAWINGS

The features and advantages of the various embodiments will become apparent from the following detailed description in which:

FIG. 1 illustrates a high-level block diagram of an example industrial-grade emulsifying machine, according to one embodiment;

FIG. 2 illustrates an example industrial-grade emulsifying machine, according to one embodiment;

FIG. 3 illustrates an example industrial grade high-shear mixer, according to one embodiment; and

FIG. 4 illustrates an example method of making sauce (mayonnaise) from animal fat using an industrial-grade emulsifying machine such as a high-shear mixer, according to one embodiment.

### DETAILED DESCRIPTION

Animal fat has many uses but is rarely used in emulsions or sauces (e.g., mayonnaise). This may for any number of reasons including, for example, the animal fat may oxidize and become rancid resulting in a short shelf life, animal fat is harder to create tiny particles that result in a good emulsification (produces loose combination of fata and water), and/or misconception that animal fat is not healthy. However, animal fat offers many benefits over traditional fruit, flower, nut, vegetable, and seed oils including, for example, it is usually cheaper and more plentiful commercially than other oils because it is available as an unused byproduct on many animal-raising farms and to many meat-product producers, it is better-tasting than most fruit, flower, nut, vegetable, and seed oils, and despite common misconceptions to the contrary, studies suggest that animal fat has a plurality of health benefits, including anti-carcinogenic properties.

Animal fats have been utilized by some to make homemade sauces for personal and casual use. Sauces made at home for personal use can be produced using mixing or blending by hand or with a commercial home mixer or blender. Such methods are untenable for making high quantities of sauces because emulsion by hand or with commercial home mixers and blenders will typically cause the resulting sauce to separate within a few weeks. Moreover, mixing or blending by hand or with a home mixer or blender cannot produce sufficient sauce quantity for commercial-scale production or sale.

What is needed is a method for producing sauce using animal fat on a commercial scale to obtain the quantity, quality, and life of traditional commercial-grade sauce (e.g., mayonnaise) with the benefits of animal fat over common fruit, nut, seed, flower, and vegetable oils. The use of an industrial-grade emulsifying machine such as a high-shear mixer can be utilized to ensure that the animal fat particles are made sufficiently small to produce a good emulsion. An anti-rancidity or antioxidant (e.g., vitamin E, rosemary oil extract (ROE), bovine casein hydrolysate (BCH)) may be utilized in the mix to prevent the animal fat from becoming rancid and enabling longer shelf life.

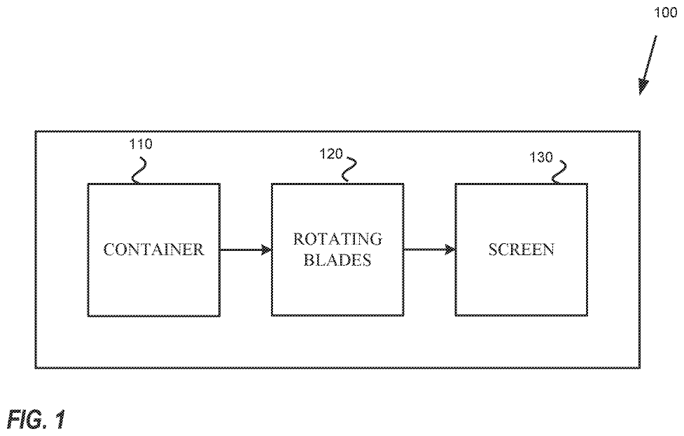

FIG. 1 illustrates a high-level block diagram of an example industrial-grade emulsifying machine 100. The machine 100 includes a container 110 for holding the contents. Within the container 110 are a plurality of rotating blades 120 to mix the contents together. The mixed contents are pushed through one or more screens 130 to create the small bubbles for the emulsification.

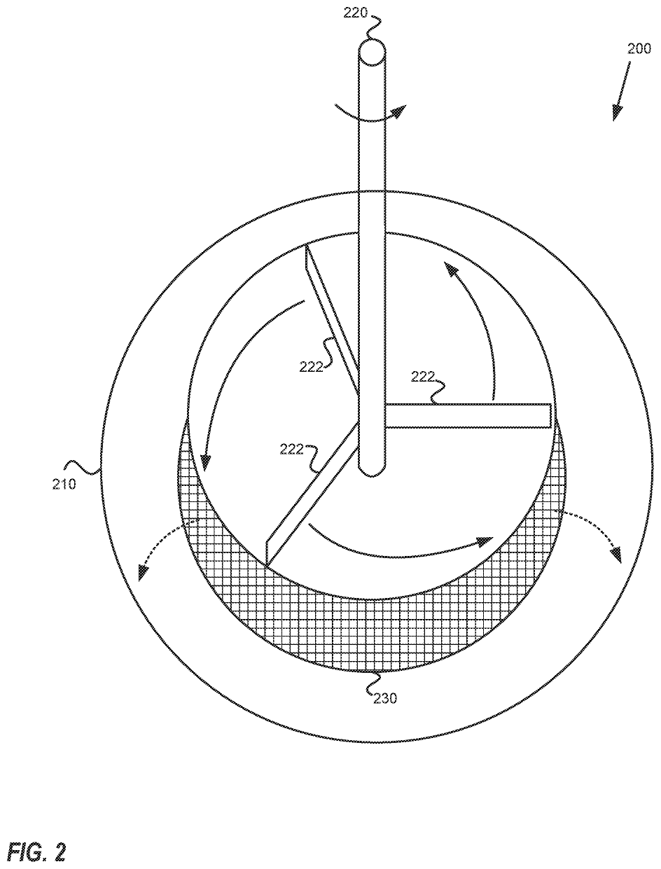

FIG. 2 illustrates a high-level example industrial-grade emulsifying machine 200. The machine includes a container 210 for holding the contents. A rotor 220 is located in a center of the container 210. The rotor 220 includes a plurality (three illustrated) of blades 222 extending therefrom. The rotor 220 is configured to be powered by a motor (not illustrated) to enable the rotor 220 and blades 222 to rotate at variable speeds in order to mix the contents. Surrounding the blades 22 is a screen 230 that the contents are pushed through to create the small bubbles for the emulsification.

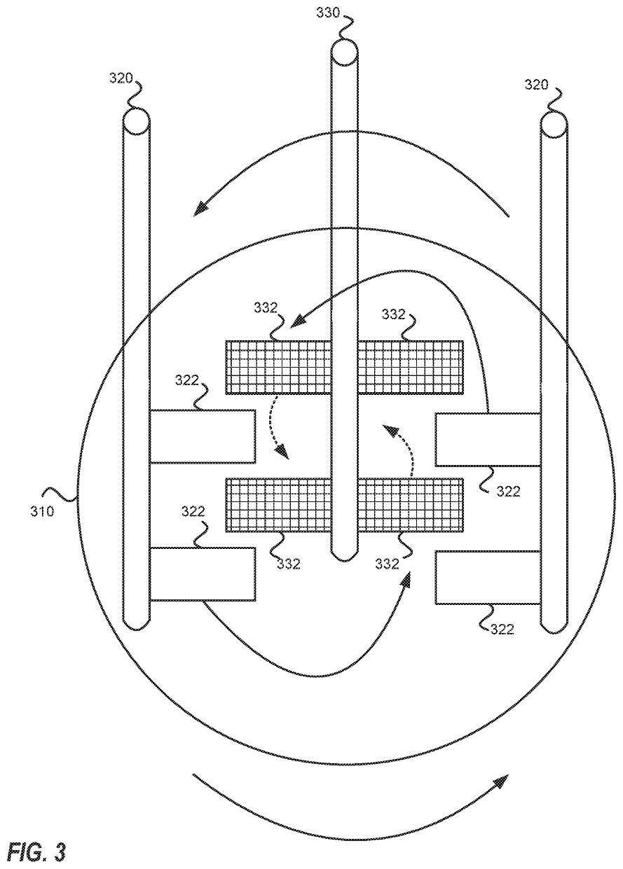

FIG. 3 illustrates a high-level example industrial grade high-shear mixer 300. The high-shear mixer 300 includes a container 310 for holding the contents. One or more rotors (two illustrated) 320 are located within the container 310. The rotors 320 have one or more blades (two illustrated) 322 located thereon. The rotors 320 are configured to be powered by one or more electric motors (not illustrated), which enable the one or more rotors 320 to rotate at variable speeds around the container 310. One or more stators (one illustrated) 330 are located (illustrated as being centrally located) within the container 310. The stator 330 includes a plurality of screens 332 extending therefrom. The contents being mixed by the blades 322 pass through the screens 332 to create the small bubbles for the emulsification.

The rotors 320 are configured to rotate at a sufficiently high speed to generate a pulling force on ingredients introduced into the container 310. As the rotors 320 pulls the ingredients, they contact the blades 322, which then generate a centrifugal pushing force to push the same ingredients into the screens 332. As the ingredients are pushed between the blades 332 and the screens 332, they are milled into smaller and smaller particles by a process called shearing. Contributing to the shearing process is the hydraulic forcing out of the ingredients through the screens 332 back into the container 310 containing the ingredients to be mixed, from where the mixture is circulated by being pulled back into the rotors 320 and forced back out of the screens 332 continuously until the emulsion is generated to the user's specifications.

The emulsifying machine 200 or high-shear mixer 300 may include additional components that were not illustrated. For example, the devices 200, 300 may include one or more mixing tanks in which ingredients may be introduced into the container 210, 310 to be mixed. The devices 200, 300 may include fill tanks where the finished product (mayonnaise) is routed and stored. The finished product may then be packaged (e.g., bottling). The devices 200, 300 may be one of several types, including vacuum, batch, inline, etc.

The shearing process disclosed may be used to produce a highly stable emulsion of mayonnaise made from animal fat that will be, and remain, highly stable for a sufficiently long period of time as to allow it to be used in commercial sale. The inclusion of the anti-rancidity/antioxidant in the mixture will prevent the animal fat from oxidizing.

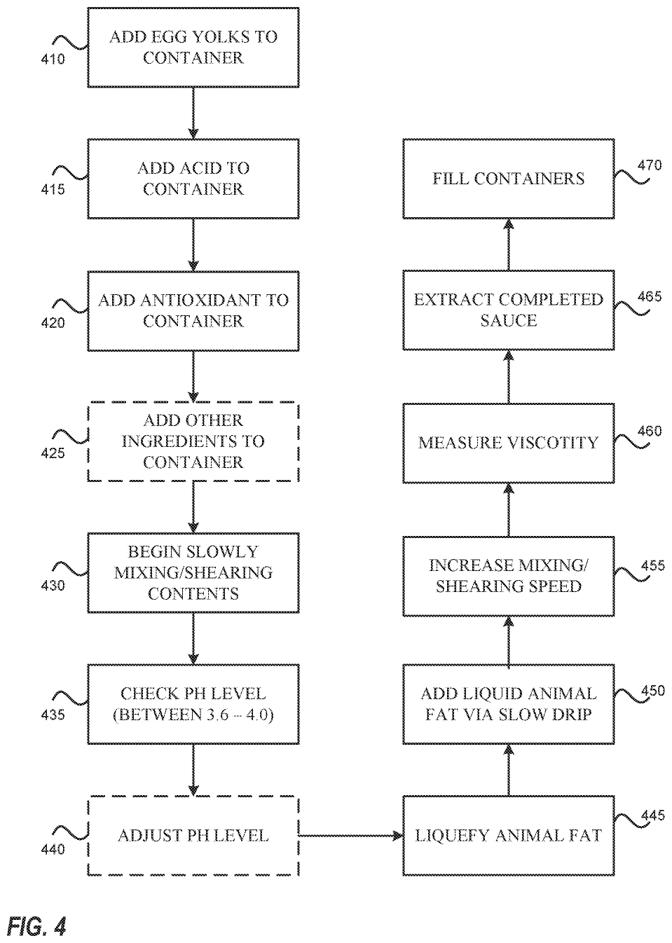

FIG. 4 illustrates an example method of making sauce (mayonnaise) from animal fat using an industrial-grade emulsifying machine such as a high-shear mixer. An appropriate number of egg yolks are added into a container (e.g., 110, 210, 310) to act as the emulsifier 410. An appropriate amount of acid (e.g., lemon juice, lime juice, vinegar) is added to the container to, among other things, control the pH of the sauce 415. An appropriate amount of an anti-rancidity or antioxidant (e.g., vitamin E, rosemary oil extract (ROE), bovine casein hydrolysate (BCH)) is added to the container to prevent the fat from oxidizing 420. Additional ingredients (e.g., herbs, spices, other flavorings) may optionally be added to the container for, among other things, taste 425. The high-shear mixer is then started on a low speed to begin to mix all the ingredients in the container 430. While the mixing is occurring, pH levels of the mixture are monitored 435. Generally, pH levels for a mayonnaise mixture should be between approximately 3.6 and 4.0 to limit the risk of micro bacterial growth in the mixture. If required, the pH may be adjusted by adjusting the amount of acid in the mixture (e.g., adding more acid) 440.

Next, the animal fat is prepared to be introduced into the mixture (e.g., create a liquid) 445. The animal fat, which may be solid at room temperature, may be in solid form so may be warmed to liquefy it. The liquefied animal fat is then introduced into the mixture by slow drip until an appropriate quantity has been provided 450 The speed of the mixing of the high-shear mixer is increased as the animal fat is added (as volume of mixture increases) 455. The viscosity of the mixture is measured to ascertain when the sauce is done 460. The sauce will have the desired consistency and texture when the viscosity is in the desired range of 30,000-40,000 cp. The mixing continues until the desired viscosity is obtained.

Once the desired viscosity is obtained, the completed mixture can then be extracted or pumped from the container 465. The extracted mixture may be provided to a fill machine that can be used to fill and seal containers to house the product 470. The containers may then be transported and commercially sold.

According to one embodiment, the ingredients of the mixture may contain approximately 60-80% animal fat (e.g., lard, grease, filtered liquid fat, unfiltered liquid fat), 20-40% egg yolks, 0.05-1% acid (e.g., lemon juice), less than 1% rancidity regulator (e.g., vitamin E), and less than 2% of other ingredients (e.g., spices, seasonings, organics) for taste.

The types of products, including the type of high-shear mixer, described above and shown in the accompanying figures are not intended to be limiting, but to encompass any type thereof. The pH and viscosity levels identified above are intended to describe only preferred levels for the embodiment of the method described herein and are not intended to limit the scope thereto. Animal fat as identified above may be animal fat as a byproduct from any animal, including pig, duck, cow, and chicken, and is not intended to be limiting thereto.

Although the disclosure has been illustrated by reference to specific embodiments, it will be apparent that the disclosure is not limited thereto as various changes and modifications may be made thereto without departing from the scope. The various embodiments are intended to be protected broadly within the spirit and scope of the appended claims.

What is claimed is:

1. A method of producing mayonnaise, comprising:
adding one or more egg yolks into a mixing tank in a high-shear mixer;
adding an acid to the mixing tank;
adding an antioxidant to the mixing tank;
operating the high-shear mixer at a low speed to begin to mix ingredients within the mixing tank to create a mixture;
monitoring pH levels of the mixture, wherein the pH level may be adjusted to maintain within a desired range;
introducing animal fat into the mixture by slow drip;
increasing speed of the high-shear mixer as the animal fat is added to the mixture; and
measuring viscosity of the mixture, wherein the viscosity may be adjusted to maintain within a desired range.

2. The method of claim 1, further comprising warming the animal fat to liquefy it prior to introducing it.

3. The method of claim 1, further comprising pumping the mixture to a fill machine.

4. The method of claim 1, further comprising filling and sealing containers of the mixture for transport and commercial sale.

5. The method of claim 1, wherein the acid includes vinegar.

6. The method of claim 1, wherein the acid includes lemon juice.

7. The method of claim 1, wherein the acid includes lime juice.

8. The method of claim 1, wherein the antioxidant includes rosemary oil extract (ROE).

9. The method of claim 1, wherein the antioxidant includes bovine casein hydrolysate (BCH).

10. The method of claim 1, wherein the antioxidant includes vitamin E.

11. The method of claim 1, further comprising adding additional ingredients into the mixture prior to introducing the animal fat.

12. The method of claim 11, wherein the additional ingredients include herbs.

13. The method of claim 11, wherein the additional ingredients include spices.

14. The method of claim 11, wherein the additional ingredients include flavorings.
